(19) United States
(12) Patent Application Publication
(10) Pub. No.: US 2015/0017425 A1
(43) Pub. Date: Jan. 15, 2015

(54) LIGNOCELLULOSE MATERIALS WITH COATED EXPANDED PLASTICS PARTICLES

(71) Applicant: BASF SE, Ludwigshafen (DE)

(72) Inventors: Matthias Schade, Ludwigshafen (DE); Stephan Weinkötz, Neustadt (DE); Günter Scherr, Ludwigshafen (DE); Jens Aßmann, Neustadt (DE); Dietrich Scherzer, Neustadt (DE)

(21) Appl. No.: 14/321,557

(22) Filed: Jul. 1, 2014

(30) Foreign Application Priority Data
Jul. 5, 2013 (EP) 13175212.3

(51) Int. Cl. C08L 97/02; B32B 21/02; C08L 61/24; B27N 3/08

(52) U.S. Cl. CPC C08L 97/02; B27N 3/08; B32B 21/02; C08L 61/24; B32B 2264/0214
USPC 428/327; 264/331.11; 264/331.19; 264/331.22; 264/241; 524/35; 524/14

(57) ABSTRACT

The present invention relates to lignocellulose materials which comprise
A) 30 to 98 wt % of one or more lignocellulosic substances,
B) 1 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, optionally with a curing agent, and
D) 0 to 68 wt % of additives,
   wherein component B) or the original expandable plastics particles are coated with at least one coating material before, during, or after expansion.

The present invention relates to lignocellulose materials comprising a lignocellulosic substance, coated expanded and/or expandable plastics particles, binder, optionally with a curing agent, and optionally additives, and to methods for producing them.

WO-A-2011/107900 discloses woodbase materials having improved mechanical properties and low water absorption and good processing properties, like conventional woodbase materials of equal density, that can be produced at a higher operating speed. For these materials, foamed polystyrene beads are provided with a binder and curing agent, and dried.

During the production of woodbase materials of reduced weight that comprise foamed polystyrene, and especially where the completed panels are not very thick (below 25 mm, for example), one possible consequence of the production operation is that some polystyrene beads, during the production of the cake of chips, migrate from the middle layer into the outer layer or come to lie on the surface of the chip cake. This results in poorer mechanical values and in some cases, if the polystyrene beads come to lie on or too close to the surface, in partial damage to the surface.

It was an object of the present invention, accordingly, to remedy the disadvantages identified above and in particular to produce lightweight woodbase materials having improved mechanical properties, without causing partial damage to the surface.

Found accordingly have been new and improved lignocellulose materials which comprise
A) 30 to 98 wt % of one or more lignocellulosic substances,
B) 1 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, optionally with a curing agent, and
D) 0 to 68 wt % of additives,
   and wherein component B) or the original expandable plastics particles are coated with at least one coating material before, during, or after expansion.

Also found has been a new and improved method for producing lignocellulose materials, which comprises mixing
A) 30 to 98 wt % of one or more lignocellulosic substances,
B) 1 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at lest two isocyanate groups, or mixtures thereof, and
D) 0 to 68 wt % of additives,
   where component B) or the original expandable plastics particles are coated with at least one coating material before, during, or after expansion, and subsequently compressing the mixture at elevated temperature and at elevated pressure.

The sum total of components A), B), C), and optionally D) adds up to 100%.

The term “lignocellulose material” denotes single-layer or multilayer lignocellulose materials, thus having one to five layers, preferably one to three layers, more preferably one or three layers. Lignocellulose materials in this context are understood to encompass optionally veneered chip, OSB, or fiber materials, more particularly wood fiber materials such as LDF, MDF, and HDF materials, preferably chip or fiber materials, more preferably chip materials. Materials include boards, tiles, moldings, semifinished products, or composites, preferably boards, tiles, moldings, or composites, more preferably boards.

### Component A

Lignocellulosic substances are substances which comprise lignocellulose. The amount of lignocellulose may be varied within wide ranges and is generally 20 to 100 wt %, preferably 50 to 100 wt %, more preferably 85 to 100 wt %, more particularly 100 wt % lignocellulose. The term “lignocellulose” is familiar to the skilled person.

Suitable examples of one or more lignocellulosic substances are straw, plants containing wood fiber, wood, or mixtures thereof. By two or more lignocellulosic substances are meant, in general, 2 to 10, preferably 2 to 5, more preferably 2 to 4, more particularly 2 or 3 different lignocellulosic substances.

Suitable wood comprises wood fibers or wood particles such as wood laths, wood strips, woodchips, wood dust, or mixtures thereof, preferably woodchips, wood fibers, wood dust, or mixtures thereof, more preferably woodchips, wood fibers, or mixtures thereof. Examples of suitable plants containing wood fiber are flax, hemp, or mixtures thereof. Starting materials for wood particles or wood fibers are generally lumber from forestry thinning, residual industrial lumber, and used lumber, and also woody plants and plant parts.

Wood varieties suitable for the production of the wood particles or wood fibers are any varieties, preferably spruce, beech, pine, larch, lime, poplar, ash, chestnut, and fir wood, or mixtures thereof, more preferably spruce or beech wood, or mixtures thereof, more particularly spruce wood.

The lignocellulosic substances are, in accordance with the invention, generally comminuted and used in the form of particles or fibers.

Suitable particles include sawing chips, woodchips, shavings, wood particles, optionally comminuted cereal straw, shavings, cotton stems, or mixtures thereof, preferably sawing chips, planing chips, woodchips, wood particles, shavings, or mixtures thereof, more preferably sawing chips, planing chips, woodchips, wood particles, or mixtures thereof.

The dimensions of the comminuted lignocellulosic substances are not critical and are guided by the lignocellulose material to be produced.

Large chips, as used for example for producing OSB boards, are also called strands. The average size of the particles—strands—for the production of OSB boards is generally 20 to 300 mm, preferably 25 to 200 mm, more preferably 30 to 150 mm.

Chipboard panels are generally produced using smaller chips. The particles needed for this purpose may be classified according to size by means of screen analysis. Screen analysis is described in DIN 4188 or DIN ISO 3310, for example. The average size of the particles is generally 0.01 to 30 mm, preferably 0.05 to 25 mm, more preferably 0.1 to 20 mm.

Suitable fibers include wood fibers, cellulose fibers, hemp fibers, cotton fibers, bamboo fibers, miscanthus, bagass, or mixtures thereof, preferably wood fibers, hemp fibers, bamboo fibers, miscanthus, bagass, or mixtures thereof, more preferably wood fibers, bamboo fibers, or mixtures thereof. The length of the fibers is generally 0.01 to 20 mm, preferably 0.05 to 15 mm, more preferably 0.1 to 10 mm.

The particles or fibers are generally also of pure type—that is, if only one of the aforementioned types (e.g., chips, woodchips, or wood fibers) is used, they are present in the form of mixtures whose individual parts, particles, or fibers differ in size and shape.

Processing to the desired lignocellulosic substances may take place in accordance with methods that are known per se (see, for example: M. Dunky, P. Niemz, Holzwerkstoffe and Leime, pages 91 to 156, Springer Verlag Heidelberg, 2002).

The lignocellulosic substances may be obtained, after customary drying techniques known to the skilled person, with the usual small amounts of water thereafter (within a usual, small range; so-called “residual moisture”); this water is not taken into account in the weight figures of the present invention.

The average density of the lignocellulosic substances of the invention is arbitrary, is dependent solely on the lignocellulosic substance used, and is generally 0.2 to 0.9 g/cm³, preferably 0.4 to 0.85 g/cm³, more preferably 0.4 to 0.75 g/cm³, more particularly 0.4 to 0.6 g/cm³.

For an average density in the range from 601 to 1200 kg/m³, preferably 601 to 850 kg/m³, more preferably 601 to 800 kg/m³, they are referred to as relatively high-density lignocellulosic substances, and for an average density in the range from 200 to 600 kg/m³, preferably 300 to 600 kg/m³, more preferably 350 to 600 kg/m³, as low-density lignocellulosic substances. In the case of fiberboard panels, a distinction is made between high-density fiberboard (HDF) with a density ≧800 kg/m³, medium-density fiberboard (MDF) with a density of between 650 and 800 kg/m³, and lightweight fiberboard (LDF) with a density ≦650 kg/m³.

### Component B

Component B) is composed of expanded plastics particles, which are coated with at least one binder before, during or after expansion.

Expanded plastics particles, preferably expanded thermoplastics particles, are prepared from expandable plastics particles, preferably expandable thermoplastics particles. Both are based on or consist of polymers, preferably thermoplastic polymers, which can be foamed. These polymers are known to the skilled person.

Examples of highly suitable such polymers are polyketones, polysulfones, polyoxymethylenes, PVC (plasticized and unplasticized), polycarbonates, polyisocyanurates, polycarbodiimides, polyacrylimides and polymethacrylimides, polyamides, polyurethanes, amino resins and phenolic resins, styrene homopolymers (also referred to below as “polystyrene” or “styrene polymer”), styrene copolymers, C₂-C₁₀-olefin homopolymers, C₂-C₁₀-olefin copolymers, polyesters, or mixtures thereof, preferably PVC (plasticized and unplasticized), polyurethanes, styrene homopolymer, styrene copolymer, or mixtures thereof, more preferably styrene homopolymer, styrene copolymer, or mixtures thereof, more particularly styrene homopolymer, styrene copolymer, or mixtures thereof.

The above-described, preferred or more preferred expandable styrene polymers or expandable styrene copolymers have a relatively low blowing agent content. Polymers of this kind are also referred to as “low in blowing agent”. One highly suitable process for producing expandable polystyrene or expandable styrene copolymer that is low in blowing agent is described in U.S. Pat. No. 5,112,875, expressly incorporated herein by reference.

As described, it is also possible to use styrene copolymers. These styrene copolymers advantageously include at least 50 wt %, preferably at least 80 wt %, of copolymerized styrene. Examples of comonomers contemplated include α-methylstyrene, ring-halogenated styrenes, acrylonitrile, esters of acrylic or methacrylic acid with alcohols having 1 to 8 C atoms, N-vinylcarbazole, maleic acid (and/or maleic anhydride), (meth)acrylamides and/or vinyl acetate.

The polystyrene and/or styrene copolymer may advantageously comprise in copolymerized form a small amount of a chain branching agent, i.e., of a compound having more than one, preferably two double bonds, such as divinylbenzene, butadiene and/or butanediol diacrylate. The branching agent is used generally in amounts from 0.0005 to 0.5 mol %, based on styrene.

Mixtures of different styrene (co)polymers may also be used.

Highly suitable styrene homopolymers or styrene copolymers are crystal polystyrene (GPPS), high-impact polystyrene (HIPS), anionically polymerized polystyrene or high-impact polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methyl acrylate-butadiene-styrene (MBS), methyl methacrylate-acrylonitrile-butadiene-styrene (MABS) polymers, or mixtures thereof, or used with polyphenylene ether (PPE).

Preference is give to using styrene polymers, styrene copolymers, or styrene homopolymers having a molecular weight in the range from 70 000 to 400 000 g/mol, more preferably 190 000 to 400 000 g/mol, very preferably 210 000 to 400 000 g/mol.

Polystyrene and/or styrene copolymer of this kind may be produced by any of the polymerization processes known to the skilled person—see, for example, Ullmann's Encyclopedia, Sixth Edition, 2000 Electronic Release, or Kunststoff-Handbuch 1996, volume 4 “Polystyrol”, pages 567 to 598.

Where the expanded plastics particles consist of different types of polymer, i.e., of types of polymer based on different monomers, such as polystyrene and polyethylene, or polystyrene and homo-polypropylene, or polyethylene and homo-polypropylene, these different types of polymer may be present in different weight proportions—which, however, are not critical.

The expandable plastics particles are used in general in the form of beads or pellets with an average diameter of 0.25 to 10 mm, preferably 0.4 to 8.5 mm, more preferably 0.4 to 7 mm, more particularly in the range from 1.2 to 7 mm, and advantageously have a small surface area per unit volume, in the form, for example, of a spherical or elliptical particle.

The expanded plastics particles are advantageously closed-cell. The open-cell content according to DIN-ISO 4590 is generally less than 30%.

The expanded plastics particles have a bulk density of 10 to 150 kg/m³, preferably 30 to 100 kg/m³, more preferably 40 to 80 kg/m³, more particularly 50 to 70 kg/m³. The bulk density is typically ascertained by weighing a defined volume filled with the bulk material.

The expanded plastics particles generally still contain, if any, only a low level of blowing agent. The blowing agent content of the expanded plastics particle is generally in the range from 0 to 5.5 wt %, preferably 0 to 3 wt %, more preferably 0 to 2.5 wt %, very preferably 0 to 2 wt %, based in each case on the expanded polystyrene or expanded styrene copolymer. 0 wt % here means that no blowing agent can be detected using the customary detection methods.

These expanded plastics particles can be put to further use without or with—preferably without—further measures for reduction of blowing agent, and more preferably without further intervening steps, for producing the lignocellulosic substance.

The expandable polystyrene or expandable styrene copolymer, or the expanded polystyrene or expanded styrene copolymer, typically has an antistatic coating.

The expanded plastics particles may be obtained as follows:

Compact, expandable plastics particles, typically solids with in general no cell structure, and comprising an expansion-capable medium (also called “blowing agent”), are expanded (often also called “foamed”) by exposure to heat or a change in pressure. On such exposure, the blowing agent expands, the particles increase in size, and cell structures are formed.

This expansion is carried out in general in customary foaming devices, often referred to as “pre-expanders”. Pre-expanders of this kind may be fixed installations or else movable.

Expansion may be carried out in one or more stages. Generally speaking, with the one-stage process, the expandable plastics particles are expanded directly to the desired final size.

Generally speaking, in the case of the multistage process, the expandable plastics particles are first expanded to an intermediate size, and then expanded to the desired final size in one or more further stages, via a corresponding number of intermediate sizes.

The expansion is preferably carried out in one stage.

For the production of expanded polystyrene as component B) and/or of expanded styrene copolymer as component B), in general, the expandable styrene homopolymers or expandable styrene copolymers are expanded in a known way by heating to temperatures above their softening point, using hot air or, preferably, steam, for example, and/or using pressure change (this expansion often also being termed “foaming”), as described for example in Kunststoff Handbuch 1996, volume 4 “Polystyrol”, Hanser 1996, pages 640 to 673, or in U.S. Pat. No. 5,112,875. The expandable polystyrene or expandable styrene copolymer is generally obtainable in a conventional way by suspension polymerization or by means of extrusion techniques as described above. On expansion, the blowing agent expands, the polymer particles increase in size, and cell structures are formed.

The expandable polystyrene and/or styrene copolymer is prepared in general in a conventional way, by suspension polymerization or by means of extrusion techniques.

In the case of the suspension polymerization, styrene, optionally with addition of further comonomers, is polymerized using radical-forming catalysts in aqueous suspension in the presence of a conventional suspension stabilizer. The blowing agent and any further adjuvants may be included in the initial charge in the polymerization, or added to the batch in the course of the polymerization or when polymerization is at an end. The beadlike, expandable styrene polymers impregnated with blowing agent that are obtained, after the end of polymerization, are separated from the aqueous phase, washed, dried, and screened.

In the case of the extrusion process, the blowing agent is mixed into the polymer by an extruder, for example and the material is conveyed through a die plate and pelletized under pressure to form particles or strands.

The resulting expanded plastics particles or coated expanded plastics particles can be stored temporarily and transported.

Suitable blowing agents are all blowing agents known to the skilled person, examples being aliphatic C₃ to C₁₀ hydrocarbons such as propane, n-butane, isobutane, n-pentane, isopentane, neopentane, cyclopentane and/or hexane and its isomers, alcohols, ketones, esters, ethers, halogenated hydrocarbons, or mixtures thereof, preferably n-pentane, isopentane, neopentane, cyclopentane, or a mixture thereof, more preferably commercial pentane isomer mixtures composed of n-pentane and isopentane.

The blowing agent content of the expandable plastics particle is generally in the range from 0.01 to 7 wt %, preferably 0.01 to 4 wt %, more preferably 0.1 to 4 wt %, very preferably 0.5 to 3.5 wt %, based in each case on the expandable polystyrene or styrene copolymer containing blowing agent.

### Coating of Component B

Suitable coating materials for the expandable or expanded plastics particles include all compounds of component C and also compounds K, which form a tacky layer, or mixtures thereof, preferably all compounds of component C and also compounds K which form a tacky layer, more preferably all compounds of component C. Where the coating material has been selected from components C, it is possible for coating material and component C in the lignocellulose material to be the same or different, preferably the same.

Suitable compounds K which form a tacky layer are polymers based on monomers such as vinylaromatic monomers, such as α-methylstyrene, p-methylstyrene, ethylstyrene, tert-butylstyrene, vinylstyrene, vinyltoluene, 1,2-diphenylethylene, 1,1-diphenylethylene, alkenes, such as ethylene or propylene, dienes, such as 1,3-butadiene, 1,3-pentadiene, 1,3-hexadiene, 2,3-dimethylbutadiene, isoprene, or piperylene, α,β-unsaturated carboxylic acids, such as acrylic acid and methacrylic acid, esters thereof, more particularly alkyl esters, such as C₁ to C₁₀ alkyl esters of acrylic acid, more particularly the butyl esters, preferably n-butyl acrylate, and the C₁ to C₁₀ alkyl esters of methacrylic acid, more particularly methyl methacrylate (MMA), or carboxamides, such as acrylamide and methacrylamide, for example. These polymers may optionally contain 1 to 5 wt % of comonomers, such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide, or the sodium salt of vinylsulfonic acid. The constituent monomer or monomers of these polymers are preferably one or more of styrene, butadiene, acrylic acid, methacrylic acid, C₁ to C₄ alkyl acrylates, C₁ to C₄ alkyl methacrylates, acrylamide, methacrylamide, and methylolacrylamide. Additionally suitable in particular are acrylate resins, more preferably in the form of the aqueous polymer dispersion, and also homooligomers or homopolymers of α,β unsaturated carboxylic acids or their anhydrides, and also cooligomers or copolymers of α,β unsaturated carboxylic acids and/or their anhydrides with ethylenically unsaturated comonomers.

Suitable polymer dispersions are obtainable, for example, by radical emulsion polymerization of ethylenically unsaturated monomers, such as styrenes, acrylates, methacrylates, or a mixture thereof, as described in WO-A-00/50480, preferably pure acrylates or styrene-acrylates, synthesized from the monomers styrene, n-butyl acrylate, methyl methacrylate (MMA), methacrylic acid, acrylamide, or methylolacrylamide.

The polymer dispersion or suspension can be prepared in a conventional way, for instance by emulsion, suspension, or dispersion polymerization, preferably in aqueous phase. The polymer may also be prepared by solution or bulk polymerization, optional comminution, and subsequent, conventional dispersing of the polymer particles in water.

The coating material can be contacted with the expandable plastics particles (i.e., prior to expansion, “variant I”) or during the expansion of the expandable plastics particles (i.e., during expansion, “variant II”), or with the expanded plastics particles (i.e., after expansion, “variant III”); preference is given to employing variant (II).

The plastics particles coated according to the invention may be produced, for example, by
a) melting plastics particles, preferably nonexpendable plastics particles, adding one or more coating materials and blowing agent in any order, mixing them extremely homogeneously, and foaming the mixture to form foam particles;
b) coating expandable plastics particles with one or more coating materials and foaming them to form foam particles or
c) coating expandable plastics particles with one or more coating materials during or after pre-expanding.

Furthermore, the contacting may take place using the customary methods, as for example by spraying, dipping, wetting or drumming of the expandable or expanded plastics particles with the coating material at a temperature of 0 to 150° C., preferably 10 to 120° C., more preferably 15 to 110° C., under a pressure of 0.01 to 10 bar, preferably 0.1 to 5 bar, more preferably under standard pressure (atmospheric pressure); the coating material is preferably added in the pre-expander under the conditions specified above.

### Component C

Suitable binders are resins such as phenol-formaldehyde resins, amino resins, organic isocyanates having at least 2 isocyanate groups, or mixtures thereof. The resins may be used as they are on their own, as a single resin constituent, or as a combination of two or more resin constituents of the different resins from the group consisting of phenol-formaldehyde resins, amino resins, and organic isocyanates having at least 2 isocyanate groups.

### Phenol-Formaldehyde Resins

Phenol-formaldehyde resins (also called PF resins) are known to the skilled person—see, for example, Kunststoff-Handbuch, 2nd edition, Hanser 1988, volume 10 “Duroplaste”, pages 12 to 40.

### Amino Resins

As amino resins it is possible to use all amino resins that are known to the skilled person, preferably those known for the production of woodbase materials. Resins of this kind and also their preparation are described in, for example, Ullmanns Enzyklopädie der technischen Chemie, 4th, revised and expanded edition, Verlag Chemie, 1973, pages 403 to 424 “Aminoplaste” and in Ullmann's Encyclopedia of Industrial Chemistry, Vol. A2, VCH Verlagsgesellschaft, 1985, pages 115 to 141 “Amino Resins”, and also in M. Dunky, P. Niemz, Holzwerkstoffe and Leime, Springer 2002, pages 251 to 259 (UF resins) and pages 303 to 313 (MUF and UF with a small amount of melamine), and may be prepared by reaction of compounds containing carbamide groups, preferably urea, melamine, or mixtures thereof, with the aldehydes, preferably formaldehyde, in the desired molar ratios of carbamide group to the aldehyde, preferably in water as solvent.

Setting the desired molar ratio of aldehyde, preferably formaldehyde, to the amino group which is optionally partly substituted by organic radicals, may also be done by addition of monomers bearing —NH₂ groups to completed, preferably commercial, relatively formaldehyde-rich amino resins. Monomers carrying NH₂ groups are preferably urea, melamine, or mixtures thereof, more preferably urea.

Amino resins are preferably considered to be polycondensation products of compounds having at least one carbamide group, optionally substituted to some extent by organic radicals (the carbamide group is also referred to as carboxamide group), and of an aldehyde, preferably formaldehyde; with particular preference, urea-formaldehyde resins (UF resins), melamine-formaldehyde resins (MF resins), or melamine-containing urea-formaldehyde resins (MUF resins), more particularly urea-formaldehyde resins, examples being Kaurit® glue products from BASF SE. Amino resins especially preferred in addition are polycondensation products made of compounds having at least one amino group, including amino groups partly substituted by organic radicals, and of aldehyde, in which the molar ratio of aldehyde to the amino group optionally partly substituted by organic radicals is in the range from 0.3:1 to 1:1, preferably 0.3:1 to 0.6:1, more preferably 0.3:1 to 0.45:1, very preferably 0.3:1 to 0.4:1.

The stated amino resins are typically used in liquid form, usually in suspension in a liquid medium, preferably in aqueous suspension, or else are used in solid form.

The solids content of the amino resin suspensions, preferably of the aqueous suspension, is typically 25 to 90 wt %, preferably 50 to 70 wt %.

The solids content of the amino resin in aqueous suspension may be determined according to Günter Zeppenfeld, Dirk Grunwald, Klebstoffe in der Holz-und Möbelindustrie, 2nd edition, DRW-Verlag, page 268. For determining the solids content of aminoplast glues, 1 g of aminoplast glue is weighed out accurately into a weighing pan, distributed finely on the base, and dried in a drying cabinet at 120° C. for 2 hours. After conditioning to room temperature in a desiccator, the residue is weighed and is calculated as a percentage fraction of the initial mass.

The weight figure for the binder, with regard to the aminoplast component in the binder, is based on the solids content of the corresponding component (determined by evaporating the water at 120° C. over the course of 2 hours, according to Gunter Zeppenfeld, Dirk Grunwald, Klebstoffe in der Holz-und Möbelindustrie, 2nd edition, DRW-Verlag, page 268) and, in relation to the isocyanate, more particularly the PMDI, on the isocyanate component per se, in other words, for example, without solvent or emulsifying medium.

### Organic Isocyanates

Suitable organic isocyanates are organic isocyanates having at least two isocyanate groups or mixtures thereof, more particularly all organic isocyanates or mixtures thereof that are known to the skilled person, preferably those known for the production of woodbase materials or polyurethanes. Organic isocyanates or these kinds and also their preparation and use are described in Becker/Braun, Kunststoff Handbuch, 3rd revised edition, volume 7 “Polyurethane”, Hanser 1993, pages 17 to 21, pages 76 to 88, and pages 665 to 671, for example.

Preferred organic isocyanates are oligomeric isocyanates having 2 to 10, preferably 2 to 8, monomer units and on average at least one isocyanate group per monomer unit, or mixtures thereof, more preferably the oligomeric organic isocyanate PMDI (“Polymeric Methylene Diphenylene Diisocyanate”), which is obtainable by condensation of formaldehyde with aniline and phosgenation of the isomers and oligomers formed in the condensation (see, for example, Becker/Braun, Kunststoff Handbuch, 3rd revised edition, volume 7 “Polyurethane”, Hanser 1993, page 18, last paragraph, to page 19, second paragraph, and page 76, fifth paragraph), very preferably products of the LUPRANAT® product series from BASF SE, more particularly LUPRANAT® M 20 FB from BASF SE.

### Curing Agents in Component C

The binder C) may comprise curing agents or mixtures thereof that are known to the skilled person.

Suitable curing agents include all chemical compounds of any molecular weight that bring about or accelerate the polycondensation of amino resin or phenol-formaldehyde resin, and those which bring about or accelerate the reaction of organic isocyanate having at least two isocyanate groups with water or other compounds or substrates (wood, for example) which contain —OH or —NH—, —NH₂, or ═NH groups.

Suitable curing agents for amino resins of phenol-formaldehyde resins are those which catalyze the further condensation, such as acids or their salts, or aqueous solutions of these salts.

Suitable acids are inorganic acids such as HCl, HBr, HI, H₂SO₃, H₂SO₄, phosphoric acid, polyphosphoric acid, nitric acid, sulfonic acids, as for example p-toluenesulfonic acid, methanesulfonic acid, trifluoromethanesulfonic acid, nonafluorobutanesulfonic acid, carboxylic acids such as C₁ to C₈ carboxylic acids as for example formic acid, acetic acid, propionic acid, or mixtures thereof, preferably inorganic acids such as HCl, H₂SO₃, H₂SO₄, phosphoric acid, polyphosphoric acid, nitric acid, sulfonic acids, such as p-toluenesulfonic acid, methanesulfonic acid, carboxylic acids such as C₁ to C₈ carboxylic acids as for example formic acid, acetic acid, more preferably inorganic acids such as H₂SO₄, phosphoric acid, nitric acid, sulfonic acid such as p-toluenesulfonic acid, methanesulfonic acid, and carboxylic acids such as formic acid and acetic acid.

Suitable salts are halides, sulfites, sulfates, hydrogensulfates, carbonates, hydrogencarbonates, nitrites, nitrates, sulfonates, salts of carboxylic acids such as formates, acetates, propionates, preferably sulfites, carbonates, nitrates, sulfonates, salts of carboxylic acids such as formates, acetates, and propionates, more preferably sulfites, nitrates, sulfonates, salts of carboxylic acids such as formates, acetates, and propionates, of protonated, primary, secondary, and tertiary aliphatic amines, alkanolamines, cyclic aromatic amines such as C₁ to C₈ amines, isopropylamine, 2-ethylhexylamine, di(2-ethylhexyl)amine, diethylamine, dipropylamine, dibutylamine, diisopropylamine, tert-butylamine, triethylamine, tripropylamine, triisopropylamine, tributylamine, monoethanolamine, morpholine, piperidine, pyridine, and also ammonia, preferably protonated primary, secondary, and tertiary aliphatic amines, alkanolamines, cyclic amines, cyclic aromatic amines, and also ammonia, more preferably protonated alkanolamines, cyclic amines, and also ammonia, or mixtures thereof.

Salts that may be mentioned more particularly include the following: ammonium chloride, ammonium bromide, ammonium iodide, ammonium sulfate, ammonium sulfite, ammonium hydrogensulfate, ammonium methanesulfonate, ammonium-p-toluenesulfonate, ammonium trifluoromethanesulfonate, ammonium nonafluorobutanesulfonate, ammonium phosphate, ammonium nitrate, ammonium formate, ammonium acetate, morpholinium chloride, morpholinium bromide, morpholinium iodide, morpholinium sulfate, morpholinium sulfite, morpholinium hydrogensulfate, morpholinium methanesulfonate, morpholinium p-toluenesulfonate, morpholinium trifluoromethanesulfonate, morpholinium nonafluorobutanesulfonate, morpholinium phosphate, morpholinium nitrate, morpholinium formate, morpholinium acetate, monoethanolammonium chloride, monoethanolammonium bromide, monoethanolammonium iodide, monoethanolammonium sulfate, monoethanolammonium sulfite, monoethanolammonium hydrogensulfate, monoethanolammonium methanesulfonate, monoethanolammonium p-toluenesulfonate, monoethanolammonium trifluoromethanesulfonate, monoethanolammonium nonafluorobutanesulfonate, monoethanolammonium phosphate, monoethanolammonium nitrate, monoethanolammonium formate, monoethanolammonium acetate, or mixtures thereof.

The salts are used with very particular preference in the form or their aqueous solutions. Aqueous solutions are understood in this context to be dilute, saturated, supersaturated, and also partially precipitated solutions and also saturated solutions with a solids content of salt which is not further soluble.

Phenol-formaldehyde resins may also be cured alkalinically, preferably with carbonates or hydroxides such as potassium carbonate and sodium hydroxide.

Highly suitable curing agents of organic isocyanate having at least two isocyanate groups, as for example PMDI, may be divided into four groups: amines, other bases, metal salts, and organometallic compounds; amines are preferred. Curing agents of these kinds are described in, for example, Michael Szycher, Szycher's Handbook of Polyurethanes, CRC Press, 1999, pages 10-1 to 10-20.

Additionally suitable are compounds which greatly accelerate the reaction of compounds containing reactive hydrogen atoms, more particularly containing hydroxyl groups, with the organic isocyanates.

Usefully used as curing agents are basic polyurethane catalysts, examples being tertiary amines, such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- and N-ethylmorpholine, N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, 1-azabicyclo[2.2.0]octane, 1,4-diazabicyclo[2.2.2]octane (Dabco), and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g., N,N′,N″-tris(dimethylaminopropyl)-s-hexahydrotriazine, and triethylenediamine.

Suitable metal salts and organometallic compounds are iron(II) chloride, zinc chloride, lead octoate, and tin salts such as tin dioctoate, tin diethylhexoate, and dibutyltin dilaurate, preferably tin salts such as tin dioctoate, tin diethylhexoate, and dibutyltin dilaurate, more particularly mixtures of tertiary amines and organic tin salts.

Suitability as further bases is possessed by amidines, such as 2,3-dimethyl-3,4,5,6-tetrahydropyrimidine, tetraalkylammonium hydroxides, such as tetramethylammonium hydroxide, alkali metal hydroxides, such as sodium hydroxide, and alkali metal alkoxides, such as sodium methoxide and potassium isopropoxide, and also by alkali metal salts of long-chain fatty acids having 10 to 20 C atoms and optionally pendant OH groups.

Further examples of curing agents for amino resins are found in M. Dunky, P. Niemz, Holzwerkstoffe und Leime, Springer 2002, pages 265 to 269, such curing agents for phenol-formaldehyde resins are found in M. Dunky, P. Niemz, Holzwerkstoffe und Leime, Springer 2002, pages 341 to 352, and such curing agents for organic isocyanates having at least 2 isocyanate groups are found in M. Dunky, P. Niemz, Holzwerkstoffe und Leime, Springer 2002, pages 385 to 391.

### Component D)

The lignocellulose materials of the invention may comprise, as component D, additives known to the skilled person and commercially customary, in amounts of 0 to 68 wt %, preferably 0 to 10 wt %, more preferably 0.5 to 8 wt %, more particularly 1 to 3 wt %.

Examples of suitable additives include hydrophobicizing agents such as paraffin emulsions, antifungal agents, formaldehyde scavengers, such as urea or polyamines, and flame retardants, extenders, and fillers. Further examples of additives are found in M. Dunky, P. Niemz, Holzwerkstoffe und Leime, Springer 2002, pages 436 to 444.

### Amounts of the Components in the Lignocellulose Material

The total amount of the coating material on the expanded plastics particles B) {based on the amount of the uncoated plastics particles} is in the range from 0.01 to 20 wt %, preferably 0.05 to 15 wt %, more preferably 0.1 to 10 wt %.

Even after pressing has taken place to form the lignocellulose material, preferably woodbase material, preferably multilayer lignocellulose material, more preferably multilayer woodbase material, the coated, expanded plastics particles B) are generally present in a virtually unmelted state. This means that in general the plastics particles B) have not penetrated the lignocellulose particles or impregnated them, but they are instead distributed between the lignocellulose particles. The plastics particles B) can be separated from the lignocellulose typically by physical methods, after the comminution of the lignocellulose material, for example.

The total amount of the coated expanded plastics particles B), based on the lignocellulose-containing, preferably wood-containing substance, is in the range from 1 to 25 wt %, preferably 3 to 20 wt %, more preferably 5 to 15 wt %.

The total amount of the binder C), based on the lignocellulose substances, is generally in the range from 1 to 50 wt %, preferably 2 to 15 wt %, more preferably 3 to 10 wt %, with the amount
a) of the phenol-formaldehyde resin, based on the lignocellulose substances, being generally in the range from 0 to 50 wt %, preferably 4 to 20 wt %, more preferably 5 to 15 wt %,
b) of the amino resin (calculated as solid, based on the lignocellulose substances) being generally in the range from 0 to 45 wt %, preferably 4 to 20 wt %, more preferably 5 to 15 wt %, and
c) of the organic isocyanate, based on the lignocellulose substances, being generally in the range from 0 to 7 wt %, preferably 0.1 to 5 wt %, more preferably 0.5 to 4 wt %.

### Multilayer Method

The present invention further relates to a method for producing a multilayer lignocellulose material comprising at least three layers, with either only the middle layer or at least some of the middle layers comprising a lignocellulosic substance as defined above, or with at least one further layer, apart from the middle layer or at least some of the middle layers, comprising a lignocellulosic substance as defined above, the components for the individual layers being layered one atop another and compressed at elevated temperature and elevated pressure.

The average density of the multilayer lignocellulose material, preferably woodbase material, of the invention, preferably of the three-layer lignocellulose material, preferably woodbase material, of the invention, is generally not critical.

Relatively high-density multilayer, preferably three-layer, lignocellulose materials, preferably woodbase materials, of the invention typically have an average density in the range from at least 600 to 900 kg/m³, preferably 600 to 850 kg/m³, more preferably 600 to 800 kg/m³.

Low-density multilayer, preferably three-layer, lignocellulose materials, preferably woodbase materials, of the invention typically have an average density in the range from 200 to 600 kg/m³, preferably 300 to 600 kg/m³, more preferably 350 to 500 kg/m³.

Preferred parameter ranges and also preferred embodiments for the average density of the lignocellulose-containing, preferably wood-containing substance and for the components and also their preparation processes, A), B), C), and D), and also the combination of the features, correspond to those described above.

Middle layers in the sense of the invention are all layers which are not the outer layers.

In one preferred embodiment the outer layers contain no expanded plastics particles B).

The multilayer lignocellulose material, preferably multilayer woodbase material, of the invention preferably comprises three lignocellulose layers, preferably wood material layers, the outer layers in total generally being thinner than the inner layer or layers.

The binder used for the outer layers is typically an amino resin, as for example urea-formaldehyde resin (UF), melamine-formaldehyde resin (MF), melamine-urea-formaldehyde resin (MUF), or the binder C) of the invention. The binder used for the outer layers is preferably an amino resin, more preferably a urea-formaldehyde resin, very preferably an amino resin in which the molar formaldehyde-to-—NH₂-groups ratio is in the range from 0.3:1 to 3:1.

The thickness of the multilayer lignocellulose material, preferably multilayer woodbase material, of the invention varies with the field of use and is situated generally in the range from 0.5 to 100 mm, preferably in the range from 10 to 40 mm, more particularly 12 to 40 mm.

The methods for producing multilayer woodbase materials are known in principle and described for example in M. Dunky, P. Niemz, Holzwerkstoffe and Leime, Springer 2002, pages 91 to 150.

One example of a method for producing a multilayer woodbase material of the invention is described hereinafter.

Component B, composed of expandable plastics particles, is first of all foamed and coated with coating material.

The expandable plastics pellets comprising blowing agent were pre-expanded in a commercially available pressurizable EPS pre-expander (from Erlenbach) having a capacity of 180 liters (about 50 cm in diameter and about 100 cm in height) to form foam beads (amount of Kaurit Light 200 pellets introduced: 2000 g). During the pre-expansion, the coating materials in 27 wt % solution (in water) were injected into the pressurizable pre-expander.

The coated component B) thus obtained may then be used further directly or after storage.

After the wood has been chipped, the chips are dried. Then any coarse and fine fractions are removed. The remaining chips are sorted by screening or classifying in a stream of air. The coarser material is used for the middle layer, the finer material for the outer layers.

The outer-layer chips are glue-coated, or mixed, separately from the middle-layer chips, with component C), with curing agents—these curing agents are preferably admixed shortly before the use of the component C)— and optionally with component D). This mixture is referred to below as outer-layer material.

The middle-layer chips are glue-coated, or mixed, separately from the outer-layer chips, with the coated component B), component C) with curing agents—these curing agents are preferably admixed shortly before the use of the component C)— and optionally with component D). This mixture is referred to below as middle-layer material.

The chips are subsequently scattered.

First the outer-layer material is scattered onto the shaping belt, then the middle-layer material—comprising the coated components B), C), and optionally D)—and finally outer-layer material one more time. The outer-layer material is divided such that both outer layers contain approximately equal amounts of material. The three-layer chip cake produced in this way is subjected to cold (generally room-temperature) precompaction and then to hot pressing.

Pressing may take place by any methods known to the skilled person. The cake of wood particles is typically pressed to the desired thickness at a pressing temperature of 150 to 230° C. The pressing time is normally 3 to 15 seconds per mm of panel thickness. A three-layer chipboard panel is obtained.

The mechanical strength may be determined by measurement of the transverse tensile strength in accordance with EN 319.

The effects of the coating of component B) are that migration of the individual plastics particles to the surface is reduced, suppressed, or prevented, and that the total amount of binder in the lignocellulose material of the invention is reduced.

Lignocellulose materials, more particularly multilayer woodbase materials, are an inexpensive alternative to solid wood, representing a sparing use of resources; they have great significance, and are used for producing articles of all kinds and in the construction sector, more particularly for the production of furniture and furniture parts (in furniture construction), of packaging materials, of laminate flooring, and as building materials, in house construction or in interior fitment, or in motor vehicles.

The expandable or expanded plastics particles are suitable for producing lignocellulosic moldings (use).

### EXAMPLES

### Preparation of the Coated Component B)

Pre-expanded Kaurit Light 200 was mixed with 5 wt % of a 13 wt % strength aqueous solution/suspension of a urea-formaldehyde glue (Kaurit® Leim 347 from BASF SE) in a plastic vessel by stirring and shaking at room temperature until the expanded plastics particles were uniformly wetted (about 5 minutes for about 250 g of mixture).

### Production of the Panels

The glue used was urea-formaldehyde glue (Kaurit® Leim 347 from BASF SE). The solids content was adjusted to 67 wt % with water in each case.

Production of the outer-layer material

In a mixer, to 180 g of chips, 30.4 g of a glue liquor composed of 100 parts of Kaurit®-Leim 347 glue and 1 part of a 52% strength aqueous ammonium nitrate solution, 0.5 part of urea, 0.5 part of a 60% aqueous paraffin dispersion, and 40 parts of water were applied.

### Production of the Middle-Layer Material

In a mixer, 330 g of chips (component A) and 33 g of coated expanded polymer (component B) were mixed as per table. Then 62.7 g of a glue liquor composed of 100 parts of Kaurit®-Leim 347 glue and 4 parts of a 52% strength aqueous ammonium nitrate solution, 1.3 parts of urea, and 0.8 part of a 60% aqueous paraffin dispersion were applied.

### Compressing of the Glue-Treated Chips

The glue-treated chips were filled into a 30×30 cm mold as follows:

First of all, half of the outer-layer material was scattered into the mold. Then 50% to 100% of the middle-layer material was applied as a layer over it. Lastly, the second half of outer-layer material was applied as a layer over this, and the whole was subjected to cold precompaction. This was followed by pressing in a hot press (pressing temperature 210° C., pressing time 120 s). The specification thickness of the panel was 16 mm in each case.

### Investigation of the Lightweight, Wood-Containing Substance

### Density:

The density was determined 24 hours after production. For this purpose, the ratio of mass to volume of a test specimen was determined at the same moisture content. The square test specimens had a side length of 50 mm, with an accuracy of 0.1 mm. The thickness of the test specimen was measured in its center, to an accuracy of 0.05 mm. The accuracy of the balance used for determining the mass of the test specimen was 0.01 g. The gross density ρ (kg/m³) of a test specimen was calculated by the following formula:

ρ=m/(b₁*b₂*d)*10⁶

Here:
m is the mass of the test specimen, in grams, and
b₁, b₂, and d are the width and thickness of the test specimen, in millimeters.

A precise description of the procedure can be found in DIN EN 323, for example.

### Transverse Tensile Strength:

The transverse tensile strength is determined perpendicular to the board plane. For this purpose, the test specimen was loaded to fracture with a uniformly distributed tensile force. The square test specimens had a side length of 50 mm, with an accuracy of 1 mm, and angles of exactly 90°. Moreover, the edges were clean and straight. The test specimens were bonded to the yokes by means of a suitable adhesive, an epoxy resin, for example, and dried for at least 24 hours in a controlled-climate cabinet at 20° C. and 65% atmospheric humidity. The test specimen prepared in this way was then clamped into the testing machine in a self-aligning manner with a shaft joint on both sides, and then loaded to fracture at a constant rate, with the force needed to achieve this being recorded. The transverse tensile strength fₜ (N/mm²) was calculated by the following formula:

fₜ=Fₘₐₓ/(a*b)

Here:
Fₘₐₓ is the breaking force in newtons
a and b are the length and width of the test specimen, in millimeters.

A precise description of the procedure can be found in DIN EN 319, for example.

### Flexural Strength

The flexural strength was determined by applying a load in the middle of a test specimen lying on two points. The test specimen had a width of 50 mm and a length of 20 times the nominal thickness plus 50 mm, but not more than 1050 mm and not less than 150 mm. The test specimen was then placed flatly onto two bearing mounts, the inter-center distance of which was 20 times the thickness of the test specimen, and the test specimen was then loaded to fracture in the middle with a force, this force being recorded. The flexural strength fₘ (N/mm²) was calculated by the following formula:

fₘ=(3*Fₘₐₓ*I)/(2*b*t²)

Here:
Fₘₐₓ is the breaking force in newtons
I is the distance between the centers of the bearing mounts, in millimeters
b is the width of the test specimen, in millimeters
t is the thickness of the test specimen, in millimeters.

A precise description of the procedure can be found in DIN EN 310.

### Screw Pullout Resistance

The screw pullout resistance was determined by measuring the force needed to pull out a screw in an axially parallel fashion from the test specimen. The square test specimens had a side length of 75 mm, with an accuracy of 1 mm. First of all, guide holes with a diameter of 2.7 mm (±0.1 mm), and depth of 19 mm (±1 mm) were drilled perpendicular to the surface of the test specimen into the central point of the surface. Subsequently, for the test, a steel screw with nominal dimensions of 4.2 mm×38 mm, having a ST 4.2 thread in accordance with ISO 1478 and a pitch of 1.4 mm, was inserted into the test specimen, with 15 mm (±0.5 mm) of the whole screw being inserted. The test specimen was fixed in a metal frame and, via a stirrup, a force was applied to the underside of the screw head, the maximum force with which the screw was pulled out being recorded.

A precise description of the procedure can be found in DIN EN 320.

The results of the tests are summarized in the table.

The quantity figures are based in each case on the dry substance. When parts by weight are stated, the dry wood or the sum of the dry wood and the filler was taken as 100 parts. When % by weight is stated, the sum of all the dry constituents of the lightweight, wood-containing material is 100%.

The tests in the table without addition of coated component B serve as a comparison and were carried out in accordance with WO-A-2011/018373.

| | | Component | Coated | Uncoated | |
|---|---|---|---|---|---|
| | Target | A (wood) in | component B | component B | |
| Experi- | density | middle layer | (expanded | (expanded | UF glue |
| ment | [kg/m³] | [g] | polymer) [g] | polymer) [g] | [g] |
| 1^{[1]} | 400 | 330 | — | 33 | 63 |
| 2^{[1]} | 450 | 368 | — | 37 | 70 |
| 3^{[1]} | 500 | 393 | — | 39 | 75 |
| 4 | 400 | 330 | 33 | | 63 |
| 5 | 450 | 368 | 37 | | 70 |
| 6 | 500 | 393 | 39 | | 75 |
| 7 | 400 | 330 | 33 | | 52 |
| 8 | 500 | 393 | 39 | | 62 |

^{[1]}= Comparative experiment according to WO-A-2011/018373

| | | Transverse | Flexural | Screw pullout |
|---|---|---|---|---|
| Experi- | Density | tensile strength | strength | resistance |
| ment | [kg/m³] | [N/mm²] | [N/mm²] | [N] |
| 1^{[1]} | 424 | 0.44 | 9.12 | 283 |
| 2^{[1]} | 465 | 0.63 | 12.53 | 413 |
| 3^{[1]} | 496 | 0.76 | 11.89 | 382 |
| 4 | 405 | 0.47 | 8.90 | 288 |
| 5 | 379 | 0.40 | 7.46 | 220 |
| 6 | 468 | 0.59 | 13.15 | 417 |
| 7 | 385 | 0.39 | 9.19 | 265 |
| 8 | 477 | 0.59 | 9.09 | 371 |

^{[1]}= Comparative experiment according to WO-A-2011/018373

1-16. (canceled)

17. A lignocellulose material which comprises
A) 30 to 98 wt % of one or more lignocellulosic substances,
B) 1 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, optionally with a curing agent, and
D) 0 to 68 wt % of additives,
wherein component B) or the original expandable plastics particles are coated with at least one coating material before, during, or after expansion.

18. The lignocellulose material according to claim 17, wherein the total amount of the coating material on the expanded plastics particles B) is in the range from 0.01 to 20 wt %.

19. The lignocellulose material according to claim 17, wherein the total amount of the coating material on the expanded plastics particles B) is in the range from 0.05 to 15 wt %.

20. The lignocellulose material according to claim 17, wherein the total amount of the coating material on the expanded plastics particles B) is in the range from 0.1 to 10 wt %.

21. The lignocellulose material according to claim 17, wherein the coating material is selected from the group consisting of all compounds of component C and compounds K, which form a tacky layer, or mixtures thereof.

22. The lignocellulose material according to claim 17, wherein the lignocellulosic substances are straw, plants containing wood fiber, wood, or mixtures thereof.

23. The lignocellulose material according to claim 17, wherein component B) is composed of expanded thermoplastics particles.

24. A method for producing a lignocellulose material according to claim 17, which comprises mixing
A) 30 to 98 wt % of one or more lignocellulosic substances,
B) 1 to 25 wt % of expanded plastics particles having a bulk density in the range from 10 to 150 kg/m³,
C) 1 to 50 wt % of a binder selected from the group consisting of amino resin, phenol-formaldehyde resin, organic isocyanate having at least two isocyanate groups, or mixtures thereof, and
D) 0 to 68 wt % of additives,
where component B) or the original expandable plastics particles are coated with at least one coating material before, during, or after expansion, and subsequently compressing the mixture at elevated temperature and at elevated pressure.

25. A method for producing a multilayer lignocellulose material comprising at least three layers, where either only the middle layer or at least some of the middle layers comprises or comprise a lignocellulosic substance as defined in claim 17, or where as well as the middle layer or at least some of the middle layers, at least one further layer comprises a lightweight lignocellulosic substance as defined in claim 17, the components for the individual layers being layered one atop another and compressed at elevated temperature and at elevated pressure.

26. The method according to claim 24, wherein none of the outer layers contains expanded plastics particles B).

27. A lignocellulose material obtainable by a method according to claim 24.

28. A multilayer lignocellulose material obtainable by a method according to claim 24.

29. A method for producing articles of all kinds and in the construction sector which comprises utilizing the lignocellulose material according to claim 17.

30. A method for producing furniture and furniture components, packaging materials, or laminate floors, or as construction materials which comprises utilizing the lignocellulosic material according to claim 17.

31. Expanded plastics particles having a bulk density in the range from 10 to 150 kg/m³, or expandable plastics particles comprising a coating material selected from the group consisting of all compounds of component C and also compounds K, which form a tacky layer, or mixtures thereof.

32. A process for producing lignocellulosic moldings which comprises utilizing the expandable or expanded plastics particles according to claim 31.
